(19) United States
(12) Patent Application Publication
(10) Pub. No.: US 2023/0330526 A1
(43) Pub. Date: Oct. 19, 2023

(54) CONTROLLING AGENTS IN A VIDEO GAME USING SEMANTIC MACHINE LEARNING AND A NATURAL LANGUAGE ACTION GRAMMAR

(71) Applicant: GOOGLE LLC, Mountain View, CA (US)

(72) Inventor: Anna Kipnis, San Bruno, CA (US)

(21) Appl. No.: 17/788,229

(22) PCT Filed: Apr. 30, 2020
(86) PCT No.: PCT/US2020/030667

§ 371 Date: Jun. 22, 2022

Related U.S. Application Data
(60) Provisional application No. 62/989,202, filed on Mar. 13, 2020.

(51) Int. Cl. A63F 13/422; G06N 5/025

(52) U.S. Cl. CPC A63F 13/422; G06N 5/025

(57) ABSTRACT

A semantic natural language processing (NLP) machine learning (ML) model accesses an expression space that includes first natural language phrases that are mapped to actions that are available to an agent in a video game. The semantic NLP ML model receives a second natural language phrase that represents a stimulus for the agent in the video game. One of the actions for the agent is selected based on comparisons of the first natural language phrases and the second natural language phrase. The agent in the video game is then caused to perform the selected one of the actions. In some cases, the expression space is constructed based on an action grammar that defines one or more sentence structures that include one or more tokens that are replaced by natural language phrases to form natural language sentences in the expression space.

### BACKGROUND

Video games typically include entities (referred to herein as “agents”) that perform actions in response to stimuli from a player, the agent's environment or context, or another agent. For example, nonplayer characters (NPCs) can interact with a character controlled by the player based on stimuli received from the character such as statements made by the character or actions performed by the character. For another example, multiple NPCs can interact with each other based on statements or actions exchanged between the multiple NPCs. For yet another example, an NPC can interact with objects in the environment based on the received stimuli. Game developers program agents using bespoke scripting and explicit mapping between a predetermined set of stimuli and the corresponding actions performed by the agent. This approach does not handle unexpected stimuli or emergent behavior such as the behavior that can result from the interactions between an inventive player (or players in a multiplayer game) and an NPC or between multiple NPCs. When a stimulus has not been explicitly scripted or mapped by the game developer, the videogame either does not respond to the stimulus or responds to the stimulus with a message that indicates that the stimulus has not been understood. Furthermore, creating the script or map for an agent in a video game requires knowledge of a scripting language such as Lua, JavaScript, C #, or Python, or an understanding of visual node editing and other abstract scripting approaches, which limits the ability of people that are not proficient in these techniques to participate in creating agent behavior.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that controls actions of agents in a video game using a semantic natural language processing (NLP) machine learning (ML) model according to some embodiments.

FIG. 2 is a block diagram of a cloud-based system that controls actions of agents in a video game using a semantic NLP ML model according to some embodiments.

FIG. 3 is a block diagram including a mapper that generates an expression space for an agent according to some embodiments.

FIG. 4 is a block diagram including a processor that implements a semantic NLP ML that controls actions of an agent according to some embodiments.

FIG. 5 is a flow diagram of a method of controlling actions of an agent in a video game using a semantic NLP ML according to some embodiments.

FIG. 6 is a flow diagram of a method for re-ranking results returned by a semantic NLP ML model for a set of rules according to some embodiments.

FIG. 7 is a flow diagram of a method for re-ranking results returned by a semantic NLP ML algorithm for a single rule according to some embodiments.

FIG. 8 is a flow diagram of a method for re-ranking results returned by a semantic NLP ML algorithm for a set of rules according to some embodiments.

### DETAILED DESCRIPTION

Instead of explicitly scripting or mapping stimuli to actions performed by an agent in a videogame, natural language phrases in an expression space for the agent are mapped to the actions that are available to the agent, e.g., using a metadata footprint. In some embodiments, the expression space is constructed using an action grammar that defines one or more sentence structures using tokens that are replaced by natural language phrases to form natural language sentences in the expression space. For example, an action grammar for an agent that represents a character can include the sentence structure “I [VerbGeneral] [PickupableObject].” The game actions that are implemented for the character are labeled with information indicating a token in the action grammar and the natural language phrases that can replace the token. For example, the labels for the action “pick up an object” indicate that the action works with the token [VerbGeneral], which can be replaced by the natural language phrases “take” or “pick up” to indicate the action “pick up an object” in a natural language sentence. Objects, other characters, or points of interest near the character are also labeled. For example, a label for a “cup” indicates that the object works with the token

[PickupableObject] and is replaceable by the natural language phrases “small mug” or “cup.” The expression space for the agent is then generated based on the available permutations of natural language phrases that replace the tokens in each of the sentence structures of the action grammar for the agent. For example, the natural language phrases “take” and “cup” are combined with the sentence structure “I [VerbGeneral] [PickupableObject]” to form the natural language phrase “I take cup” in the expression space for the agent. Metadata is also generated to map the natural language phrases in the expression space back to the corresponding game action.

Stimuli received by the agent are represented as natural language phrases and the natural language phrases are provided as input to a pretrained semantic natural language processing (NLP) machine learning (ML) model. The pre-trained semantic NLP ML model ranks the actions available to the agent by comparing the input natural language phrase to the natural language phrases in the expression space for the agent, e.g., operating in the input-response modality. For example, if the expression space for an agent named Bowser includes the phrase “Bowser dodges fireball,” the pre-trained semantic NLP ML model can generate a relatively high ranking for the phrase “Bowser dodges fireball” from the expression space for Bowser in response to the input phrase “Mario shoots fireballs.” The game system chooses one or more actions for an agent based on the ranked responses returned by the pre-trained semantic NLP ML model. For example, the game system can choose the action associated with the natural language phrase “Bowser dodges fireball” for the agent that represents Bowser. Thus, the stimulus of Mario shooting a fireball at Bowser results in the action of Bowser dodging the fireball. Subsequently, the phrase “Bowser dodges fireball” can be treated as an input stimulus that triggers an action selected by the semantic NLP ML model and performed by the Mario agent.

In some embodiments, one or more rules are used to modify the results provided by the semantic NLP ML model based on alternate associations between input phrases and phrases in the expression space. For example, if the semantic NLP ML model ranks “Bowser dodges fireball” as the top response to the action represented by the natural language sentence “Mario shoots fireball,” but the game developer would rather have the agent that represents Bowser “stomp” Mario in response to Mario shooting a fireball, the game developer defines a rule that biases the ranking of the phrase “Bowser stomps Mario” in the ranked responses returned by the semantic NLP ML model. In some embodiments, different sets of rules are applied based on the game state. For example, the agent that represents Bowser can be configured to have different moods by switching in and out different rules to post-process the ranked responses returned by the semantic NLP ML model. If Bowser is in a sad mood, the rule preferences actions that cause Bowser to sigh and leave the level to objectively in response to an attack from Mario. If Bowser is in a great mood, the rule preferences actions that cause Bowser to laugh in response to an attack from Mario missing. Different sets of rules can also be used to define characteristics of archetypal characters. In some embodiments, multiple layers of rules are used to individualize characters. For example, a set of archetypal rules can be used to define general traits of a class of characters (such as ores) and individual rules are used to define specific traits of an individual in the class (e.g., a bumbling incompetent orc named Goofy).

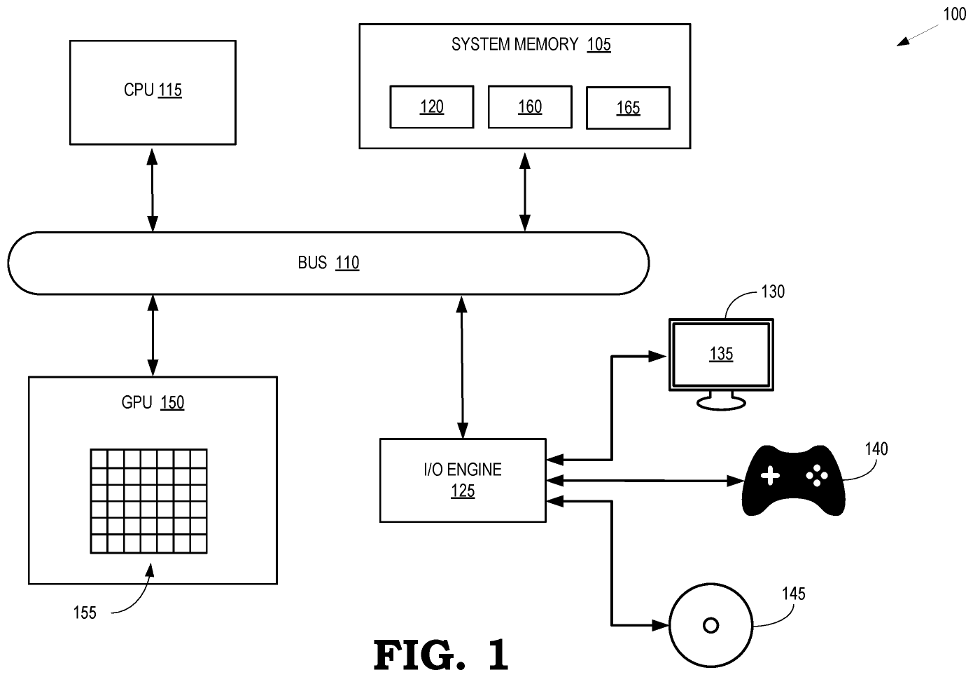

FIG. 1 is a block diagram of a processing system 100 that controls actions of agents in a video game using a semantic natural language processing (NLP) machine learning (ML) model according to some embodiments. The processing system 100 includes or has access to a memory 105 or other storage component that is implemented using a non-transitory computer readable medium such as a dynamic random-access memory (DRAM). However, some embodiments of the memory 105 are implemented using other types of memory including static RAM (SRAM), nonvolatile RAM, and the like. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes a central processing unit (CPU) 115. Some embodiments of the CPU 115 include multiple processing elements (not shown in FIG. 1 in the interest of clarity) that execute instructions concurrently or in parallel. The processing elements are referred to as processor cores, compute units, or using other terms. The CPU 115 is connected to the bus 110 and the CPU 115 communicates with the memory 105 via the bus 110. The CPU 115 executes instructions such as program code 120 stored in the memory 105 and the CPU 115 stores information in the memory 105 such as the results of the executed instructions. The CPU 115 is also able to initiate graphics processing by issuing draw calls.

An input/output (I/O) engine 125 handles input or output operations associated with a display 130 that presents images or video on a screen 135. In the illustrated embodiment, the I/O engine 125 is connected to a game controller 140 which provides control signals to the I/O engine 125 in response to a user pressing one or more buttons on the game controller 140 or interacting with the game controller 140 in other ways, e.g., using motions that are detected by an accelerometer. The I/O engine 125 also provides signals to the game controller 140 to trigger responses in the game controller 140 such as vibrations, illuminating lights, and the like. In the illustrated embodiment, the I/O engine 125 reads information stored on an external storage component 145, which is implemented using a non-transitory computer readable medium such as a compact disk (CD), a digital video disc (DVD), and the like. The I/O engine 125 also writes information to the external storage component 145, such as the results of processing by the CPU 115. Some embodiments of the I/O engine 125 are coupled to other elements of the processing system 100 such as keyboards, mice, printers, external disks, and the like. The I/O engine 125 is coupled to the bus 110 so that the I/O engine 125 communicates with the memory 105, the CPU 115, or other entities that are connected to the bus 110.

The processing system 100 includes at least one graphics processing unit (GPU) 150 that renders images for presentation on the screen 135 of the display 130, e.g., by controlling pixels that make up the screen 135. For example, the GPU 150 renders visual content to produce values of pixels that are provided to the display 130, which uses the pixel values to display an image that represents the rendered visual content. The GPU 150 includes one or more processing elements such as an array 155 of compute units that execute instructions concurrently or in parallel. Some embodiments of the GPU 150 are used for general purpose computing. In the illustrated embodiment, the GPU 150 communicates with the memory 105 (and other entities that are connected to the bus 110) over the bus 110. However, some embodiments of the GPU 150 communicate with the memory 105 over a direct connection or via other buses, bridges, switches, routers, and the like. The GPU 150 executes instructions stored in the memory 105 and the GPU 150 stores information in the memory 105 such as the results of the executed instructions. For example, the memory 105 stores a copy 160 of instructions that represent a program code that is to be executed by the GPU 150.

The CPU 115, the GPU 150, or a combination thereof execute machine learning models such as a semantic NLP ML model. In the illustrated embodiment, the memory 105 stores a program code that represents a semantic NLP ML model 165 that has been trained using a corpus of natural language data. Many text corpuses are available for training machine learning models including corpuses related to media/product reviews, news articles, email/spam/newsgroup messages, tweets, dialogues, and the like. The CPU 115 and/or the GPU 150 (or one or more of the compute units in the array 155) execute the program code that represents the trained semantic NLP ML model 165 in either input/response modality or a semantic similarity modality to generate scores that represent a degree of matching between candidate responses and an input phrase. In some embodiments, the results generated by applying the semantic NLP ML model are modified based on a set of rules, as discussed herein.

As used herein, the phrase “semantic similarity” refers to a metric defined over a set of documents or terms based on the likeness of their meaning or semantic content as opposed to similarity which can be estimated regarding their syntactical representation (e.g. their string format). A semantic similarity indicates a strength of the semantic relationship between units of language, concepts or instances, through a numerical description obtained according to the comparison of information supporting their meaning or describing their nature. Computationally, semantic similarity is estimated by defining a topological similarity, by using ontologies to define the distance between terms/concepts. For example, a metric for the comparison of concepts ordered in a partially ordered set and represented as nodes of a directed acyclic graph (e.g., a taxonomy), would be the shortest-path linking the two concept nodes. Based on text analyses, semantic relatedness between units of language (e.g., words, sentences) can also be estimated using statistical means such as a vector space model to correlate words and textual contexts from a suitable text corpus. As used herein, the phrase “input/response” refers to a metric defined over a set of documents or terms based on the likelihood that the input would elicit the response, which is determined based on meaning or semantic content as opposed to an estimate regarding their syntactical representation (e.g. their string format).

Agents in the video game are controlled using comparisons of input natural language phrases to natural language phrases that are used to tag actions that can be performed by agents in the video game. In some embodiments, the semantic NLP ML model 165 executed by the CPU 115 and/or the GPU 150 (or one or more of the compute units in the array 155) accesses an expression space that includes first natural language phrases that are mapped to actions that are available to an agent in a video game. The semantic NLP ML model 165 receives a second natural language phrase that represents a stimulus for the agent in the video game. One of the actions for the agent is selected based on comparisons of the first natural language phrases and the second natural language phrase that are performed by the semantic NLP ML model 165. In some embodiments, the semantic NLP ML model ranks the first natural language phrases based on their semantic similarity to the second (input) natural language phrase. The agent in the video game is then caused to perform the selected one of the actions. In some cases, the expression space is constructed based on an action grammar that defines one or more sentence structures that include one or more tokens that are replaced by natural language phrases to form natural language sentences in the expression space.

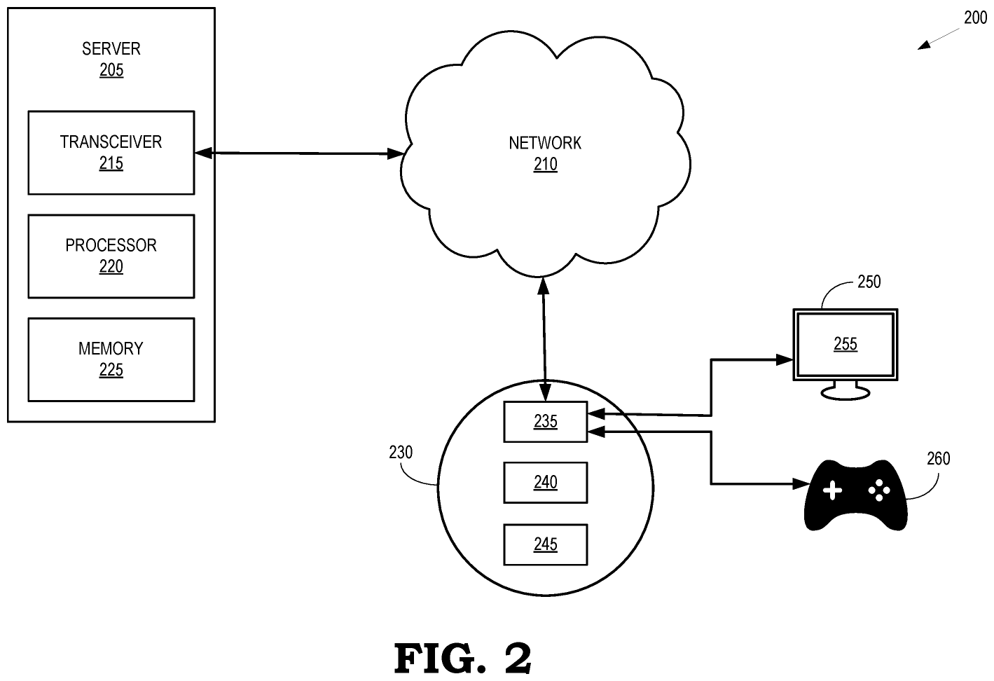

FIG. 2 is a block diagram of a cloud-based system 200 that controls actions of agents in a video game using a semantic NLP ML model according to some embodiments. The cloud-based system 200 includes a server 205 that is interconnected with a network 210. Although a single server 205 shown in FIG. 2, some embodiments of the cloud-based system 200 include more than one server connected to the network 210. In the illustrated embodiment, the server 205 includes a transceiver 215 that transmits signals towards the network 210 and receives signals from the network 210. The transceiver 215 can be implemented using one or more separate transmitters and receivers. The server 205 also includes one or more processors 220 and one or more memories 225. The processor 220 executes instructions such as program code stored in the memory 225 and the processor 220 stores information in the memory 225 such as the results of the executed instructions.

The cloud-based system 200 includes one or more processing devices 230 such as a computer, set-top box, gaming console, and the like that are connected to the server 205 via the network 210. In the illustrated embodiment, the processing device 230 includes a transceiver 235 that transmits signals towards the network 210 and receives signals from the network 210. The transceiver 235 can be implemented using one or more separate transmitters and receivers. The processing device 230 also includes one or more processors 240 and one or more memories 245. The processor 240 executes instructions such as program code stored in the memory 245 and the processor 240 stores information in the memory 245 such as the results of the executed instructions. The transceiver 235 is connected to a display 250 that displays images or video on a screen 255 and a game controller 260. Some embodiments of the cloud-based system 200 are therefore used by cloud-based game streaming applications.

The processor 220, the processor 240, or a combination thereof execute program code representative of a semantic NLP ML model in either input/response modality or a semantic similarity modality. As discussed herein, the semantic NLP ML model is pre-trained using one or more text corpuses. The results generated by applying the semantic NLP ML model are used to control agents in a video game, as discussed herein. In some embodiments, the semantic NLP ML model generates rankings of the semantic similarity of an input phrase to natural language phrases in an expression space that includes natural language phrases that are mapped to actions that are available to the agent under control. The expression space is determined using an action grammar.

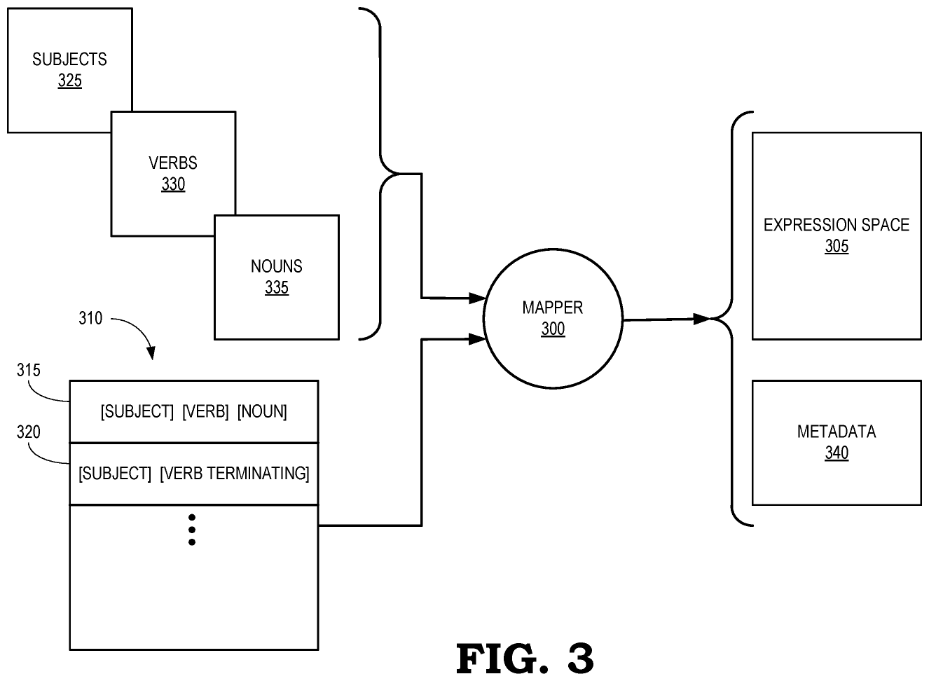

FIG. 3 is a block diagram including a mapper 300 that generates an expression space 305 for an agent according to some embodiments. The mapper 300 is implemented in some embodiments of the CPU 115 or the GPU 150 shown in FIG. 1 and some embodiments of the processor 220 shown in FIG. 2.

The mapper 300 accesses an action grammar 310 that is used to define natural language sentences in the expression space 305. In some embodiments, the action grammar 310 includes sentence structures 315, 320 that are represented as sets of one or more tokens. For example, the sentence instruction 315 is represented by the tokens [Subject], [Verb], and [Noun] and the sentence structure 320 is represented by the tokens [Subject] and [VerbTerminating]. The mapper 300 also accesses natural language words or phrases that are used to replace the tokens in the sentence structures 315, 320. In some embodiments, the natural language words or phrases include subjects 325, verbs 330, and nouns 335. The subject 325 is words or phrases that represent the agent associated with the action grammar 310, while the verbs 330 and the nouns 335 represent actions and objects, respectively, associated with the agent. The mapper 300 then generates all possible permutations of the natural language words or phrases that can be substituted for the tokens in the sentence structures 315, 320 to generate the expression space 305 for the agent. The mapper 300 also generates metadata 340 that maps the natural language phrases to the actions or objects that are available to the agent. The metadata 340 is used to trace back from the natural language sentences in the expression space 305 to the actions that are performed in the video game.

Some embodiments of the mapper 300 access game actions that are available to a first agent, e.g., game actions that are implemented by the video game and are used to control the first agent. The available actions are labeled with labels that include a token in the action grammar and the natural language words or phrases that replace that token to generate natural language sentences associated with the actions available to the first agent. In some embodiments, the mapper 300 accesses the game actions from the verbs 330. For example, the labeled actions include:
Pick up an object action
   Works with token: [VerbGeneral]
   Replaceable by natural language phrases: “take”, “pick up”
Turn to and look at object action
   Works with token: [VerbGeneral]
   Replaceable by natural language phrases: “look at”
Drop an object near something action
   Works with token: [VerbHeldObject]
   Replaceable by natural language phrases: “give”, “offer”
Play wave animation action
   Works with token: [VerbTerminating]
   Replaceable by natural language phrases: “wave”, “say hi”
Play smile animation action
   Works with token: [VerbTerminating]
   Replaceable by natural language phrases: “smile”

The mapper 300 also gathers characters, objects, and other points of interest that are proximate the first agent, e.g., in a room occupied by the first agent. In some embodiments, the mapper 300 gathers the characters, objects, and other points of interest from the nouns 335. Examples of the characters, objects, and other points of interest include, but are not limited to:
Cup
   Works with token: [NounPickupableObject]
   Replaceable by natural language phrases: “small mug”, “cup”
Book
   Works with token: [NounPickupableObject]
   Replaceable by natural language phrases: “book”
First Agent
   Works with token: [NounPerson]
   Replaceable by natural language phrases: “you”

The mapper 300 then accesses the action grammar 315 for the first agent, which is referred to herein as “I.” The first agent is the [Subject] of the natural language sentences in the expression space 305 for the first agent. Thus, in the illustrated embodiment, the action grammar 315 includes, but is not limited to, the sentence structures:
I [VerbGeneral] [NounPickupableObject]
I [VerbHeldObject] [NounObject] [NounPickupableObject] to [NounPerson]
I [VerbTerminating]

The mapper 300 generates the expression space 305 by iteratively selecting a sentence structure from the action grammar 310 and generating all the available permutations of the natural language phrases that can be substituted for the tokens in the sentence structure, e.g., as indicated by the labels associated with the actions. For example, the mapper 300 can generate the following natural language sentences using the sentence structure “I [VerbGeneral] [NounPockupableObject]” and the current actions and current objects:
I take cup, I take book, I pick up cup, I pick up book, I look at cup, I look at book

To create the corresponding metadata 340, the mapper 300 records information indicating that the sentence “I take cup” was constructed by mapping the token to “[VerbGeneral]” to “take” and “[NounPickupableObject]” to “cup. The information that represents this relationship is then stored in the metadata 340 as an additional piece of data such as:
string sentence=“I take cup”
string sentence recipe=“I [VerbGeneral] [NounPickupableObject]”
map<string, string>token to replacementword=
   {“[VerbGeneral], “take” }
   {“[NounPickupableObj ect]”, “cup”}

The metadata 340 allows the gaming system to subsequently associate a replacement natural language word or phrase with a corresponding action. The process of generating natural language sentences for the expression space 305 and the corresponding metadata 340 is then repeated for all the sentence structures in the action grammar 310. In some embodiments, the expression space 305 and the corresponding metadata 340 are constructed prior to runtime of the game and stored in a memory that is accessible by the processor executing the video game. In some embodiments, the expression space 305 and the corresponding metadata 340 are constructed or modified at runtime of the video game and stored in the memory for access by the processor executing the video game.

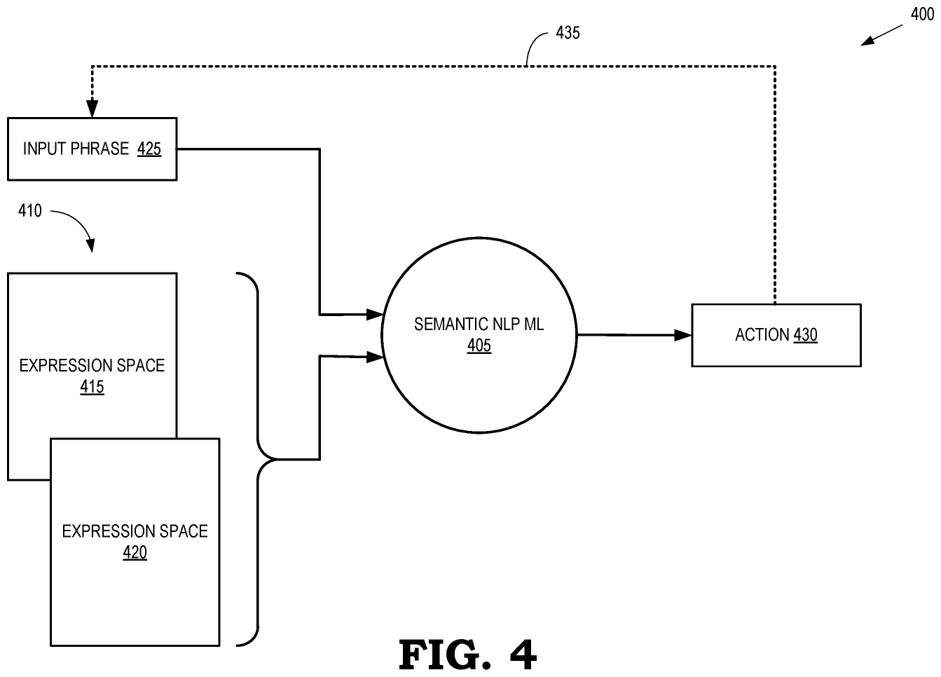

FIG. 4 is a block diagram including a processor 400 that implements a semantic NLP ML 405 that controls actions of an agent according to some embodiments. The processor 400 is implemented using some embodiments of the CPU 115 or the GPU 150 shown in FIG. 1 and some embodiments of the processor 220 shown in FIG. 2.

The processor 400 accesses a set 410 of expression spaces 415, 420 that include natural language sentences associated with actions that are available to the agents associated with the expression spaces 415, 420. For example, the expression space 415 can be associated with an agent for the character “Mario” and the expression space 420 can be associated with an agent for the character “Bowser.” Some embodiments of the expression spaces 415, 420 are generated by the mapper 300 shown in FIG. 3. The expression spaces 415, 420 include different sets of natural language sentences associated with the different actions that can be performed by the different agents. Information from the expression spaces 415, 420 is selectively provided to the semantic NLP ML 405 based on the agent that is currently under control, e.g., the agent that is to perform the selected action.

An input phrase 425 is provided to the semantic NLP ML 405. In some embodiments, the input phrase 425 is generated based on information provided by a player of the video game. For example, the player can provide input that causes Mario to shoot a fireball at Bowser, which generates an input phrase 425 of “Mario shoots fireball.” The semantic NLP ML 405 ranks the natural language sentences in the expression space 415, 420 of the agent that is to perform the selected action in response to the input phrase 425. For example, in response to the input phrase 425 of “Mario shoots fireball,” the semantic NLP ML 405 ranks the natural language sentences in the expression space 420 of the character “Bowser.” Some embodiments of the semantic NLP ML 405 rank the natural language sentences based on their degree of semantic similarity to the input phrase 425. The processor 400 then selects an action 430 based on the ranking generated by the semantic NLP ML 405, e.g., the processor 400 selects the action 430 associated with the highest ranked natural language sentence from the expression space 420. The processor 400 causes the agent to perform the action 430.

In some embodiments, the action 430 is used as a subsequent input phrase 425, as indicated by the arrow 435. For example, if the processor 400 chooses the action 430 for a second agent in response to the input phrase 425 that describes an action performed by a first agent, the action 430 can become the input phrase 425 that is used to determine a subsequent action by the first agent. In response to the new input phrase 425, the expression space 415 is provided to the semantic NLP ML 405, which ranks the natural language sentences based on their semantic similarity to the new input phrase 425. The processor 400 chooses a new action based on the ranked natural language sentences and causes the first agent to perform the selected action. In some embodiments, this process is iterated to generate a sequence of actions performed by the first and second agents. The sequence is terminated in response to reaching a predetermined number of iterations, one of the agents performing a predetermined action, or other condition or criteria.

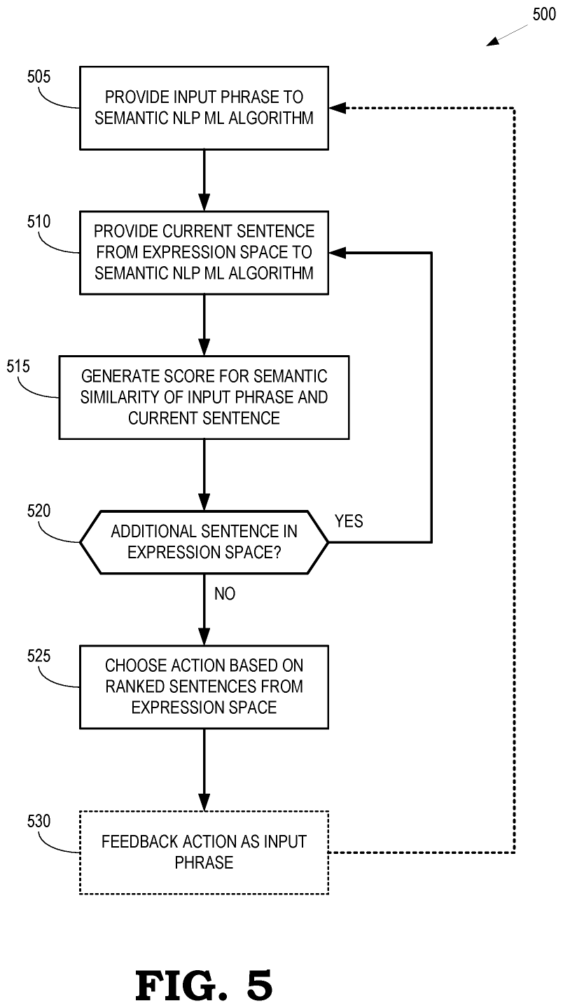

FIG. 5 is a flow diagram of a method 500 of controlling actions of an agent in a video game using a semantic NLP ML according to some embodiments. The method 500 is implemented using some embodiments of the CPU 115 or the GPU 150 shown in FIG. 1 and some embodiments of the processor 220 shown in FIG. 2.

At block 505, an input phrase is provided to the semantic NLP ML model. The input phrase is used to trigger an action or a response from an agent in the video game. As discussed herein, the actions or responses available to the agent are associated with natural language sentences in an expression space associated with the agent. At block 510, a current natural language sentence from the expression space associated with the agent is provided to the semantic NLP ML model.

At block 515, the semantic NLP ML model generates a score (or embeddings that allow for a score to be calculated) that represents a semantic similarity of the input phrase and the current sentence. At decision block 520, the processor determines whether there are additional sentences in the expression space. If so, the method 500 flows back to block 510 and a new “current” natural language sentence is selected from the expression space. If not, the method 500 flows to the block 525.

At block 525, the natural language sentences from the expression space are ranked based on the scores generated by the semantic NLP ML model and the processor chooses an action based on the ranked sentences. In some embodiments, the processor chooses the action associated with the highest ranked sentence, which is the sentence having the highest semantic similarity scores generated by the semantic NLP ML model. The processor then causes the agent to perform the selected action.

Some embodiments of the method 500 include an additional block 530 that allows the action selected by the processor to be fed back as an input phrase. In response to performing the block 530, the method 500 flows to the block 505 and the feedback phrases provided as the input phrase to the semantic NLP ML model.

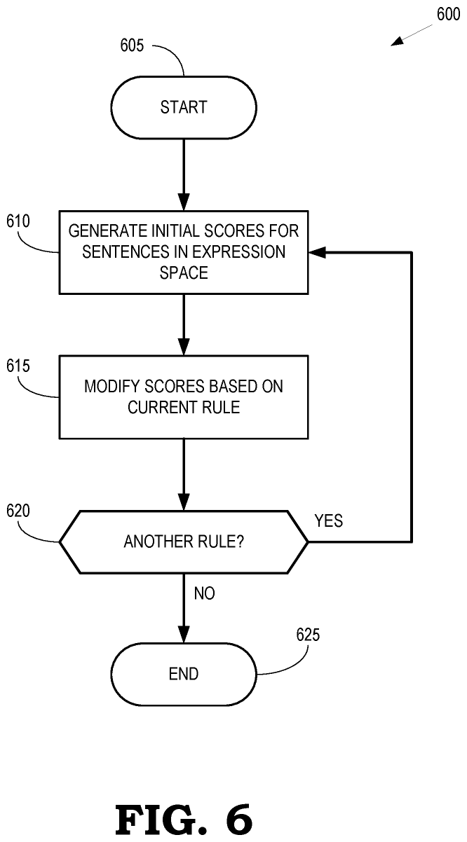

FIG. 6 is a flow diagram of a method 600 for re-ranking results returned by a semantic NLP ML model for a set of rules according to some embodiments. The method 600 is implemented in a processor that executes one or more instances of the semantic NLP ML model such as some embodiments of the CPU 115 and the GPU 150 shown in FIG. 1 and the processors 220, 240 shown in FIG. 2.

The method 600 starts at block 605. At block 610, the semantic NLP ML model generates initial scores for sentences in an expression space for an agent. As discussed herein, the semantic NLP ML model generates the scores by determining semantic similarity of the sentences to an input phrase. The semantic NLP ML model is therefore operating in the semantic similarity modality in block 610.

At block 615, scores are modified based on the current rule. In some embodiments, modifying the scores includes determining a bias based on the current rule and adding the bias to the scores. The modifications produced by rules in the set of rules considered by the method 600 are cumulative and so re-ranking based on each of the rules “stacks” with the re-ranking based on the other rules in the set, if there is more than one rule in the set. Some embodiments of techniques for re-ranking of the results from a semantic NLP ML model are disclosed in International Patent Application Serial No. PCT/US2020/030646 (Attorney Docket No. G20005), entitled “Re-Ranking Results from Semantic Natural Language Processing Machine Learning Algorithms for Implementation in Video Games,” and filed on Apr. 30, 2020, the entirety of which is incorporated by reference herein.

At decision block 620, the method 600 determines whether there are additional rules in the set to consider. If so, the method 600 flows to block 610 and a new rule from the set is considered as the current rule. If not, the method 600 flows to block 625 and the method 600 ends.

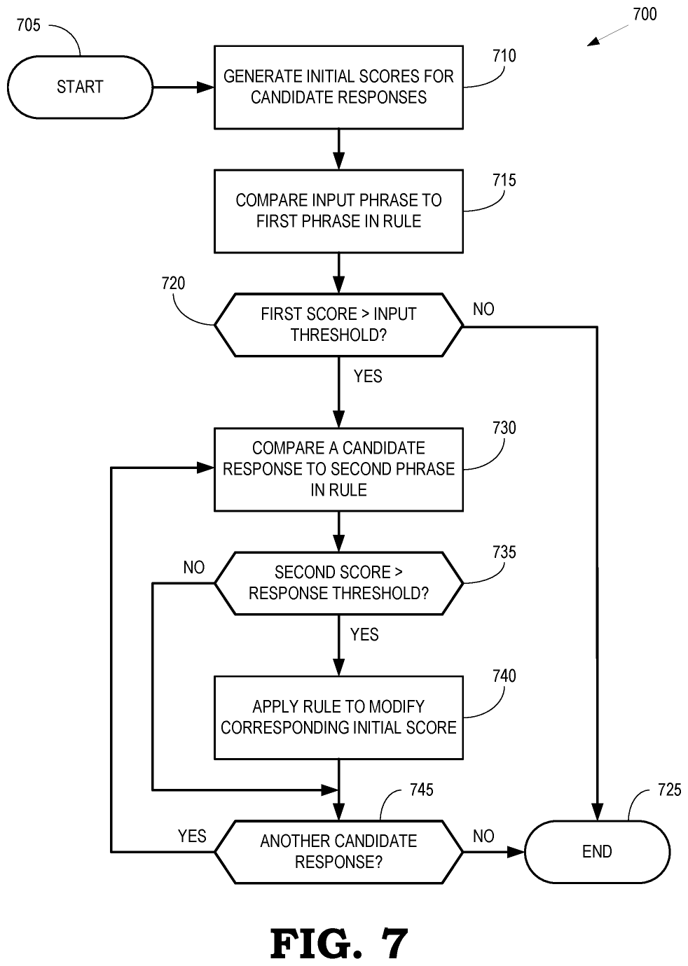

FIG. 7 is a flow diagram of a method 700 for re-ranking results returned by a semantic NLP ML algorithm for a single rule according to some embodiments. The method 700 is implemented in a processor that executes one or more instances of the semantic NLP ML algorithm such as some embodiments of the CPU 115 and the GPU 150 shown in FIG. 1 and the processors 220, 240 shown in FIG. 2.

The method 700 starts at block 705. At block 710, the semantic NLP ML algorithm generates initial scores for a set of candidate responses by comparing the candidate responses to an input phrase. The semantic NLP ML algorithm is operating in the input/response modality in block 710. Some embodiments of the semantic NLP ML algorithm operate in the semantic similarity modality.

At block 715, the semantic NLP ML algorithm compares the input phrase to a first phrase in a rule. The semantic NLP ML algorithm is operating in the semantic similarity modality in block 715 and therefore returns a score indicating the semantic similarity of the input phrase and the first phrase in the rule.

At decision block 720, the processor determines whether the first score exceeds the input threshold defined by the rule. If the first score is less than the input threshold, the method 700 flows to the block 725 and the method 700 ends without the rule being applied to modify the initial scores generated by the semantic NLP ML algorithm. If the score is greater than the input threshold, the method 700 flows to the block 730.

At block 730, the semantic NLP ML algorithm compares one of the candidate responses to the second phrase in the rule. The semantic NLP ML algorithm returns a score indicating the semantic similarity of the candidate response and the second phrase.

At decision block 735, the processor determines whether the second score exceeds the response threshold defined by the rule. If the second score is greater than the input threshold, the method 700 flows to the block 740. If the second score is less than or equal to the input threshold, the method 700 flows to the decision block 745.

At block 740, the rule is applied to modify the corresponding initial score. In some embodiments, applying the rule includes calculating an input weight and a response weight. A total bias is then calculated based on the input weight, the response weight, and a bias indicated in the rule. The total bias is added to the initial score to determine the final modified score.

At block 745, the processor determines whether there is another candidate response in the set of candidate responses. If so, the method 700 flows to the block 730 and another candidate response is considered. If not, the method 700 flows to block 725 and the method 700 ends.

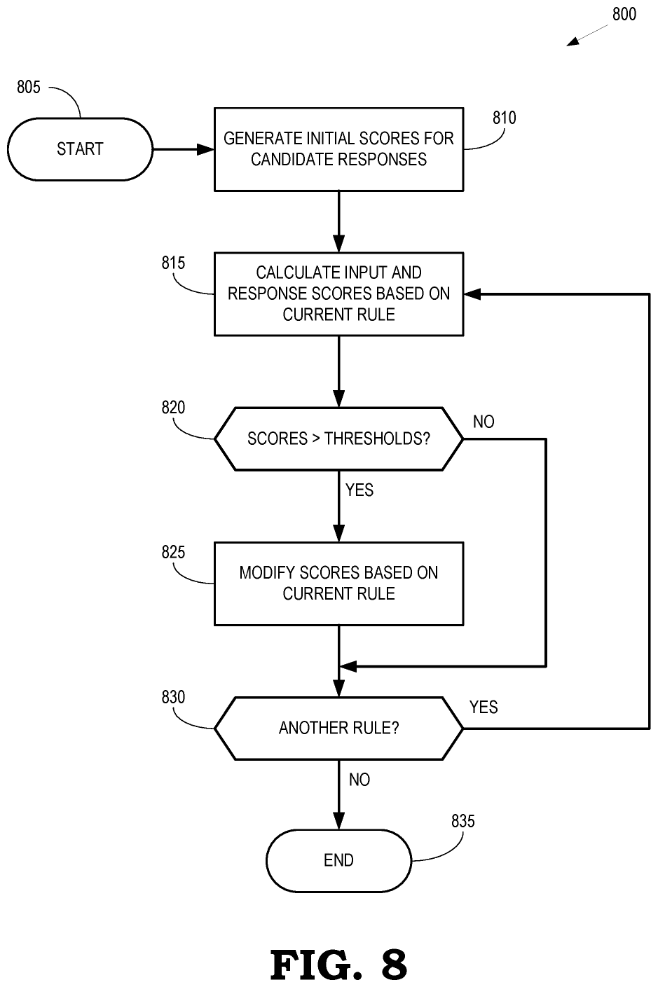

FIG. 8 is a flow diagram of a method 800 for re-ranking results returned by a semantic NLP ML algorithm for a set of rules according to some embodiments. The method 800 is implemented in a processor that executes one or more instances of the semantic NLP ML algorithm such as some embodiments of the CPU 115 and the GPU 150 shown in FIG. 1 and the processors 220, 240 shown in FIG. 2.

The method 800 starts at block 805. At block 810, the semantic NLP ML algorithm generates initial scores for a set of candidate responses by comparing the candidate responses to an input phrase. The semantic NLP ML algorithm is operating in the input/response modality in block 810.

At block 815, the semantic NLP ML algorithm calculates input and response scores using a current rule being considered by the method 800 at the current iteration. In some embodiments, the method 800 calculates the input and response scores as discussed above, e.g., with regard to FIG. 7. The semantic NLP ML algorithm is operating in the semantic similarity modality in block 815 and therefore returns scores indicating the semantic similarity of the input phrase and the first phrase in the current rule and indicating the semantic similarity of the response phrase and the second phrase in the current rule.

At decision block 820, the method 800 determines whether the input and response scores are greater than the corresponding thresholds. If so, the method 800 flows to block 825. If not, the method 800 flows to decision block 830.

At block 825, the scores are modified based on the current rule. In some embodiments, modifying the scores includes determining a bias based on the current rule and adding the bias to the scores, as discussed herein. The modifications produced by rules in the set of rules considered by the method 800 are cumulative and so re-ranking based on each of the rules “stacks” with the re-ranking based on the other rules in the set. The method 800 then flows to block 830.

At block 830, the method 800 determines whether there are additional rules in the set to consider. If so, the method 800 flows to block 810 and a new rule from the set is considered as the current rule. If not, the method 800 flows to block 835 and the method 800 ends.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

In the following some example embodiments are described.
Example 1: A method comprising:
   accessing, at a semantic natural language processing (NLP) machine learning (ML) model, an expression space comprising first natural language phrases that are mapped to actions that are available to an agent in a video game;
   receiving, at the semantic NLP ML model, a second natural language phrase that represents a stimulus for the agent in the video game;
   selecting one of the actions for the agent based on comparisons of the first natural language phrases and the second natural language phrase; and
   causing the agent in the video game to perform the selected one of the actions.
Example 2: The method of example 1, further comprising:
   constructing the expression space based on an action grammar that defines at least one sentence structure comprising at least one token that is replaced by natural language phrases to form natural language sentences in the expression space.
Example 3: The method of example 1 or 2, wherein the actions that are available to the agent are labeled with information indicating a token in the action grammar and at least one natural language phrase that replaces the token.
Example 4: The method of at least one of the preceding examples, wherein constructing the expression space further comprises generating the natural language sentences in the expression space by substituting natural language phrases in the labels of the actions for the at least one token in the at least one sentence structure defined by the action grammar.
Example 5: The method of at least one of the preceding examples, further comprising:
   generating metadata to map the natural language sentences in the expression space to a corresponding action available to the agent.
Example 6: The method of at least one of the preceding examples, wherein selecting the one of the actions for the agent comprises ranking the actions for the agent using the semantic NLP ML model operating in a semantic similarity modality so that higher rankings indicate higher degrees of semantic similarity between the second natural language phrase and the first natural language phrases.
Example 7: The method of example 6, wherein ranking the actions for the agent comprises modifying the ranking provided by the semantic NLP ML model based on alternate associations between the first natural language phrases and the second natural language phrase.
Example 8: The method of example 6 or 7, wherein modifying the ranking comprises modifying the ranking based on at least one rule that biases the rankings based on the alternate associations.
Example 9: The method of at least one of examples 6 to 8, wherein modifying the ranking comprises modifying the ranking based on different rules during based on the game state.
Example 10: The method of at least one of the examples 6 to 9, wherein modifying the ranking comprises modifying the ranking based on at least one agent-specific rule.
Example 11: The method of at least one of the examples 6 to 10, wherein selecting the one of the actions for the agent comprises selecting the highest ranked action.
Example 12: An apparatus, comprising:
   a memory configured to store a first program code representative of a semantic natural language processing (NLP) machine learning (ML) model; and
   a processor configured to execute the semantic NLP ML model to access an expression space comprising first natural language phrases that are mapped to actions that are available to an agent in a video game and receive a second natural language phrase that represents a stimulus for the agent in the video game, the processor further being configured to select one of the actions for the agent based on comparisons of the first natural language phrases and the second natural language phrase and cause the agent in the video game to perform the selected one of the actions.
Example 13: The apparatus of example 12, wherein the processor is configured to construct the expression space based on an action grammar that defines at least one sentence structure comprising at least one token that is replaced by natural language phrases to form natural language sentences in the expression space.
Example 14: The apparatus of example 12 or 13, wherein the actions that are available to the agent are labeled with information indicating a token in the action grammar and at least one natural language phrase that replaces the token.
Example 15: The apparatus of at least one of the examples 12 to 14, wherein the processor is configured to generate the natural language sentences in the expression space by substituting natural language phrases in the labels of the actions for the at least one token in the at least one sentence structure defined by the action grammar.
Example 16: The apparatus of at least one of the example 12 to 15, wherein the processor is configured to generate metadata to map the natural language sentences in the expression space to a corresponding action available to the agent.
Example 17: The apparatus of at least one of the examples 12 to 16, wherein the semantic NLP ML model is configured to rank the actions for the agent while operating in a semantic similarity modality so that higher rankings indicate higher degrees of semantic similarity between the second natural language phrase and the first natural language phrases.
Example 18: The apparatus of example 17, wherein the processor is configured to modify the ranking provided by the semantic NLP ML model based on alternate associations between the first natural language phrases and the second natural language phrase.
Example 19: The apparatus of example 17 or 18, wherein the processor is configured to modify the ranking based on at least one rule that biases the rankings based on the alternate associations.
Example 20: The apparatus of at least one of the examples 17 to 19, wherein the processor is configured to modify the ranking based on different rules that are selected based on a game state.
Example 21: The apparatus of at least one of the examples 17 to 20, wherein the processor is configured to modify the ranking based on at least one agent-specific rule.
Example 22: The apparatus of at least one of the examples 17 to 21, wherein the processor is configured to select the highest ranked action.
Example 23: A non-transitory computer readable medium embodying a set of executable instructions, the set of executable instructions to manipulate at least one processor to perform the method of any of examples 1 to 11.
Example 24: A system to perform the method of any of examples 1 to 11.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
accessing, at a semantic natural language processing (NLP) machine learning (ML) model, an expression space comprising first natural language phrases that are mapped to actions that are available to an agent in a video game;
receiving, at the semantic NLP ML model, a second natural language phrase that represents a stimulus for the agent in the video game;
selecting one of the actions for the agent based on comparisons of the first natural language phrases and the second natural language phrase; and
causing the agent in the video game to perform the selected one of the actions.

2. The method of claim 1, further comprising:
constructing the expression space based on an action grammar that defines at least one sentence structure comprising at least one token that is replaced by natural language phrases to form natural language sentences in the expression space.

3. The method of claim 1, wherein the actions that are available to the agent are labeled with information indicating a token in the action grammar and at least one natural language phrase that replaces the token.

4. The method of claim 1,
wherein constructing the expression space further comprises generating the natural language sentences in the expression space by substituting natural language phrases in the labels of the actions for the at least one token in the at least one sentence structure defined by the action grammar.

5. The method of claim 1,
further comprising:
generating metadata to map the natural language sentences in the expression space to a corresponding action available to the agent.

6. The method of claim 1,
wherein selecting the one of the actions for the agent comprises ranking the actions for the agent using the semantic NLP ML model operating in a semantic similarity modality so that higher rankings indicate higher degrees of semantic similarity between the second natural language phrase and the first natural language phrases.

7. The method of claim 6, wherein ranking the actions for the agent comprises modifying the ranking provided by the semantic NLP ML model based on alternate associations between the first natural language phrases and the second natural language phrase.

8. The method of claim 6, wherein modifying the ranking comprises modifying the ranking based on at least one rule that biases the rankings based on the alternate associations.

9. The method of claim 6, wherein modifying the ranking comprises modifying the ranking based on different rules during based on the game state.

10. The method of claim 6,
wherein modifying the ranking comprises modifying the ranking based on at least one agent-specific rule.

11. The method of claim 6,
wherein selecting the one of the actions for the agent comprises selecting the highest ranked action.

12. An apparatus, comprising:
a memory configured to store a first program code representative of a semantic natural language processing (NLP) machine learning (ML) model; and
a processor configured to execute the semantic NLP ML model to access an expression space comprising first natural language phrases that are mapped to actions that are available to an agent in a video game and receive a second natural language phrase that represents a stimulus for the agent in the video game, the processor further being configured to select one of the actions for the agent based on comparisons of the first natural language phrases and the second natural language phrase and cause the agent in the video game to perform the selected one of the actions.

13. The apparatus of claim 12, wherein the processor is configured to construct the expression space based on an action grammar that defines at least one sentence structure comprising at least one token that is replaced by natural language phrases to form natural language sentences in the expression space.

14. The apparatus of claim 12, wherein the actions that are available to the agent are labeled with information indicating a token in the action grammar and at least one natural language phrase that replaces the token.

15. The apparatus of claim 12, wherein the processor is configured to generate the natural language sentences in the expression space by substituting natural language phrases in the labels of the actions for the at least one token in the at least one sentence structure defined by the action grammar.

16. The apparatus of claim 12, wherein the processor is configured to generate metadata to map the natural language sentences in the expression space to a corresponding action available to the agent.

17. The apparatus of claim 12, wherein the semantic NLP ML model is configured to rank the actions for the agent while operating in a semantic similarity modality so that higher rankings indicate higher degrees of semantic similarity between the second natural language phrase and the first natural language phrases.

18. The apparatus of claim 17, wherein the processor is configured to modify the ranking provided by the semantic NLP ML model based on alternate associations between the first natural language phrases and the second natural language phrase.

19. The apparatus of claim 17, wherein the processor is configured to modify the ranking based on at least one rule that biases the rankings based on the alternate associations.

20. The apparatus of claim 17, wherein the processor is configured to modify the ranking based on different rules that are selected based on a game state.

21. The apparatus of claim 17, wherein the processor is configured to modify the ranking based on at least one agent-specific rule.

22. The apparatus of claim 17, wherein the processor is configured to select the highest ranked action.

23. (canceled)

24. (canceled)
